(19) United States
(12) Patent Application Publication
(10) Pub. No.: US 2011/0301980 A1
(43) Pub. Date: Dec. 8, 2011

(54) Automated Medical Image Storage System

(75) Inventors: Gary S. Martucci, Algonquin, IL (US); Michael Pajeau, Bartlett, IL (US); John Christopher Rauch, Warwick, RI (US)

(73) Assignee: SIEMENS MEDICAL SOLUTIONS USA, INC., Malvern, PA (US)

(21) Appl. No.: 13/045,821

(22) Filed: Mar. 11, 2011

Related U.S. Application Data
(60) Provisional application No. 61/357,574, filed on Jun. 23, 2010.
(60) Provisional application No. 61/350,944, filed on Jun. 3, 2010.

(51) Int. Cl. G06Q 50/00

(52) U.S. Cl. 705/3

(57) ABSTRACT

An automated medical image storage system comprises an interface, a configuration interface and an output processor. The interface acquires a sequence of images of patient vessels both prior to and following introduction of contrast agent into the vessels and subtracts a mask image representing background detail in the absence of a contrast agent to produce data representing a DSA sequence of digitally subtracted images enhancing vessel structure. The configuration interface enables a user to configure image processing (e.g., pixel shift, edge enhancement) and selection of images from the sequence of images for automatic documented archiving in an archival system by determining criteria to select images associated with one of arterial, venous, or capillary phases of blood flow. The output processor automatically initiates storage of images selected from the sequence of images in response to the determined criteria.

This is a non-provisional application of provisional application Ser. No. 61/357,574 filed Jun. 23, 2010, by J. C. Rauch and provisional application Ser. No. 61/350,944 filed Jun. 3, 2010, by J. C. Rauch, both of which are incorporated herein by reference.

### FIELD OF THE INVENTION

This invention concerns an automated medical image storage system for automatically initiating processing and storage of images associated with one of arterial, venous, or capillary phases of blood flow selected from a sequence of images in response to the determined criteria.

### BACKGROUND OF THE INVENTION

Selected images from an angiographic study are recorded and documented (often termed “filming”). The term filming originates from when hard copy records of angiographic procedures were kept and maintained, in which case sheets of film that contained the images were stored in patient records. Images of an imaging study are typically stored electronically on a picture archiving and communication system (PACS). During an interventional procedure, angiographic (higher energy X-ray) images are used for diagnosis or treatment evaluation and fluoroscopic (lower energy X-ray) images are used for medical device navigation and administration of treatment. Accordingly, it is common practice that only angiographic images are documented and sent to a PACS system.

In known systems a user evaluates each image in an angiography image sequence, selects the images to include in procedure documentation and initiates image processing on each of the selected images. Some hospitals store all images acquired during a procedure. Due to the large amount of storage space required to do this, hospitals alternatively may only store selected images from the procedure. In this case, the system operator (a technician or in some cases a physician) manually reviews the images, selects each image to be stored, performs some image processing to improve the image quality, adds desired annotations, and saves these changes as single frame images on the system. The user further initiates an electronic transfer of the generated single frame images to the PACS. The current process of storing images to a PACS is labor intensive, repetitive, and prolongs a workflow associated with the procedure. A system according to invention principles addresses these deficiencies and related problems.

### SUMMARY OF THE INVENTION

A system enables automated or semi-automated storage of images acquired on an X-ray imaging system to a PACS, for example. An automated medical image storage system comprises an interface, a configuration interface and an output processor. The interface acquires a sequence of images of patient vessels both prior to and following introduction of contrast agent into the vessels and subtracts a mask image representing background detail in the absence of a contrast agent to produce data representing a DSA sequence of digitally subtracted images enhancing vessel structure. The configuration interface enables a user to configure selection of images from the sequence of images for automatic documented archiving in an archival system by determining criteria to select images associated with one of arterial, venous, or capillary phases of blood flow. The output processor automatically initiates storage of images selected from the sequence of images in response to the determined criteria.

### BRIEF DESCRIPTION OF THE DRAWING

FIG. 1 shows an automated medical image storage system, according to invention principles.

FIG. 2 shows a user interface display image enabling user configuration of automated documentation of medical images, according to invention principles.

FIG. 3 shows a flowchart of a process for automated documentation of an interventional procedure, according to invention principles.

FIG. 4 shows a flowchart of a process used by an automated medical image storage system, according to invention principles.

### DETAILED DESCRIPTION OF THE INVENTION

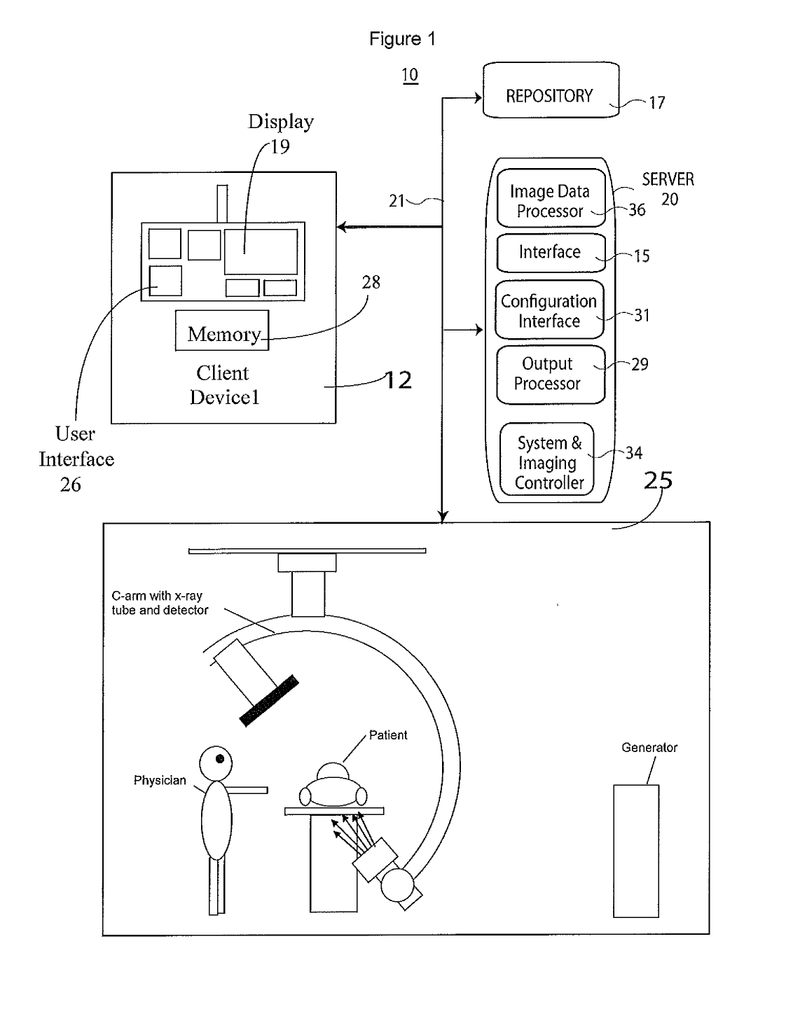

A system automates or (in another embodiment) partially automates storage of medical images to a PACS or other system and simplifies a procedural workflow. The system automatically selects and processes images to be sent to a PACS system to enable quicker image processing and turn-around to provide more consistent and timely results. FIG. 1 shows automated medical image storage system 10, according to invention principles. System 10 includes one or more processing devices (e.g., workstations or portable devices such as notebooks, Personal Digital Assistants, phones) 12 that individually include a user interface control device 26 such as a keyboard, mouse, touchscreen, voice data entry and interpretation device, display 19 and memory 28. System 10 also includes at least one repository 17, X-ray imaging modality system 25 (which in an alternative embodiment may comprise an MR (magnetic resonance) or CT scan device, for example) and server 20 intercommunicating via network 21. X-ray modality system 25 provides patient X-ray medical images using a C-arm X-ray radiation source and detector device rotating about a patient table and an associated electrical generator for providing electrical power for the X-ray radiation system. The medical images are generated in response to predetermined user (e.g., physician) specific preferences. At least one repository 17 stores medical image studies for multiple patients in DICOM compatible (or other) data format.

A medical image study individually includes multiple image series of a patient anatomical portion and an image series in turn includes multiple images. Server 20 includes interface 15, output processor 29, configuration interface 31, image data processor 36 and system and imaging controller 34. Display 19 presents display images comprising a Graphical User Interface (GUI). Imaging controller 34 controls operation of imaging device 25 in response to user commands entered via user interface 26. In alternative arrangements, one or more of the units in server 20 may be located in device 12 or in another device connected to network 21.

Interface 15 acquires from imaging system 25 a sequence of images of patient vessels both prior to and following introduction of contrast agent into the vessels and subtracts a mask image representing background detail in the absence of a contrast agent to produce data representing a DSA sequence of digitally subtracted images enhancing vessel structure. Configuration interface 31 enables a user to configure selection of images from the sequence of images for automatic documented archiving in an archival system by determining criteria to select images associated with one of arterial, venous, or capillary phases of blood flow. Image data processor 36 applies image processing and other functions to image data before transfer of images to a destination. Output processor 29 automatically initiates storage of images selected from the sequence of images in response to the determined criteria.

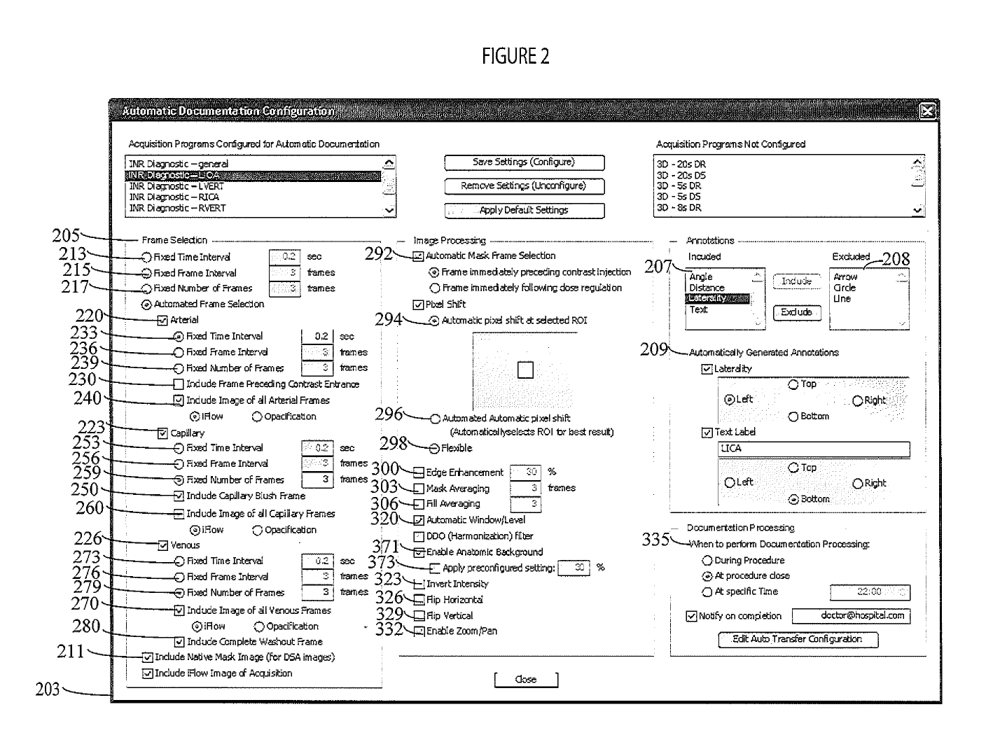

FIG. 2 shows user interface display image 203 enabling user configuration of automated documentation of medical images. A user is able to configure how automated storage is to be performed by system 10 including where the “filmed” images are sent (destination), what types of images (such as angiography, fluoroscopy) are to be stored, and how the images are to be stored. In selecting how the images are to be stored, the user is advantageously able to select if the storage parameters are applied to all stored images or if specific images or groups of images are stored using acquisition programs (collection of image acquisition settings) having different storage parameters. A user configures storage parameters determining, how storage frames are selected including whether the image processing to be applied to each frame 205 (for a fixed time or frame interval or a fixed number of frames, for example).

In storing images to a PACS, for example, system 10 enables selected annotations to be excluded. A user is able to select from a list, those annotations to be included in an image to be stored. Specifically, existing types of annotations 207 are selectable to be stored (e.g. measurements, graphics, text labels, laterality) with an image and items 208 (e.g., arrow, circle line) are selectable to be excluded. The user interface display image 203 also enables user configuration of automatically generated annotations 209 (e.g., laterality, text label) that are to be added to each frame and selection of annotation location. System 10 enables a user to add annotations to the images before sending images to a PACS for storage. Some examples of these types of annotations are: laterality indicators, text descriptions describing the vessel imaged (e.g. LICA, LAD, CIRC, RENAL), and treatment indicator (e.g. post angioplasty, post verapamil, pre treatment). Automated annotation options are configurable to be triggered on some additional information (e.g. acquisition program or Series name). User interface display image 203 enables user configuration of annotation options including, type of annotation, location of annotation and annotation text. Annotations are user (or system) specified graphics to be added to one or more images in an image sequence to provide additional information or highlight a feature in an image. User configuration image 203 enables a user to specify which annotations to include and which not to include in data associated with an image and enables automatic generation of specific annotations for specific images to be stored.

User interface display image 203 enables user configuration of selection of image frames to be stored including, native mask image 211 (if storage is of digitally subtracted images) as well as configuration of storage. Specifically image storage may be configured to be evenly spaced by fixed time interval 213, evenly spaced by fixed frame spacing interval 215 and evenly spaced by fixed number of frames 217. System 10 in response to configuration data entered via image 203 selects individual images in an image sequence to be documented having a fixed time interval or a fixed frame interval or employs advanced image selection. In addition to selection of images in an image sequence, image data processor 36 derives digital subtraction angiography (DSA) images by subtracting a mask image of background detail including vessels acquired in the absence of contrast agent from image of vessels acquired in the presence of contrast agent.

Interface 15 acquires images in a sequence at fixed time intervals and indicates a time at which individual images are acquired in data associated with the individual images. A subset of images in the sequence may be selected in response to configuration data. The subset may start with an image in the sequence (e.g. a first image or mask image) and additional images are selected based on image timestamps so images closest to a desired fixed time interval are selected. For example, a sequence of 10 images is acquired at a rate of 20 Hz and the images have relative acquisition timestamps, 0.00 s, 0.05 s, 0.10 s, 0.15 s, 0.20 s, 0.25 s, 0.30 s, 0.35 s, 0.40 s, and 0.45 s. Image data processor 36 selects images at a fixed time interval of 0.2 s, and selects images having timestamps, 0.00 s, 0.20 s, and 0.40 s. A user may also configure image selection to sample every 2^{nd}, 3^{rd}, or n^{th} image in a sequence. For example, if a sequence has 10 images, image data processor 36 selects images at a fixed frame interval of 3 images and selects images 1, 4, 7, and 10 of the sequence. In one embodiment imaging system 25 employs a variable acquisition frame rate involving a first image acquisition rate followed by a lower image acquisition rate after a fixed time interval. System 10 enables a user to configure selection of images based on time stamp or frame interval enabling a user to customize selection of images the user is interested in.

Image data processor 36 identifies a number of images to be documented and determines an image sampling interval to provide the identified images. The sampling may be evenly spaced in time or evenly spaced based on frame interval. System 10 and configuration image 203 enables a user to select image acquisition that identifies either a fixed or variable frame rate to acquire images containing meaningful data in a sequence of images. This image selection shows treatment device placement (e.g. in the cases of needle guidance, radio-frequency probe placement, biopsy tool placement, or stent placement), but fails to adequately select images in a sequence for vasculature examination.

Image data processor 36 in a further embodiment selects specific images in a sequence based on the content of the image in response to selection criteria associated with image content. Images are identified as being associated with arterial, capillary, and venous phases of vascular blood flow and processor 36 selects images based on image content such as blood flow phase. Image data processor 36 identifies independent and unique sets of images from the sequence respectively containing images of arteries, capillaries, and veins. Arterial, capillary and venous blood flow phase images provide different information to a physician for use in different types of procedure. Display image 203 presented on display 19 enables a user to configure selection of images from a sequence for a selected arterial, capillary or venous phase and enables a user to determine how the images are to be sampled within a particular phase. Display image 203 also enables a user to configure selection of a maximum capillary blush image. The maximum capillary blush image contains the most information concerning the capillary phase compared to another image of the sequence. A user is also able to employ configuration image 203 to identify, label and store an image preceding contrast agent injection into vessels.

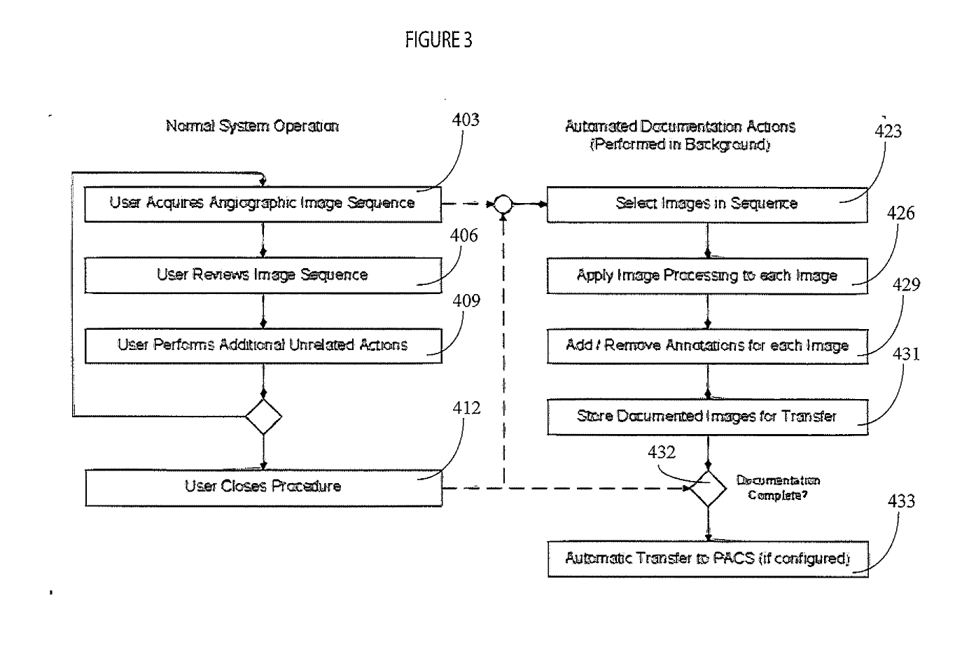

FIG. 3 shows a flowchart of a process for automated documentation of an interventional procedure. Normal system operation involves user initiation of acquisition of images using an imaging system in step 403 and the user reviews the acquired images in step 406. A user initiates performance of additional unrelated functions in step 409 and terminates the procedure in step 412 following of one or more iterations of steps 403, 406 and 409. The normal system operation is supplemented with an automated image processing and documentation process performed transparently as a background function without user interaction in response to predetermined configuration data. Image data processor 36 of automated image processing and documentation system 10, in response to predetermined configuration data, selects images in a sequence in step 423 and applies image processing functions to the selected images in step 426. Imaging system 25 acquires a sequence of images that depict patient anatomy. These images are used primarily for diagnosis or evaluation of treatment.

Image data processor 36 in response to predetermined configuration data, adds and removes annotations to individual images in step 429 and stores resultant documented images for transfer in step 431. Upon determination documentation is complete in step 432 image data processor 36 in step 433 automatically transfers the documented images to a PACs for storage. Display image 203 also enables user configuration of intelligent frame selection using vessel phase information enabling selection of storage of images of a selected vessel phase (arterial 220, capillary 223 and venous 226 phases of blood flow). Display image 203 further enables user configuration of manner of storage of the individual blood flow phase images. Specifically, for arterial vessel phase image storage, a user is able to select storage of a frame preceding contrast introduction 230, evenly spaced frames during arterial phase (fixed time interval 233, fixed frame spacing 236, fixed number of frames 239) and storage of all arterial frames 240 and a last arterial frame.

Display image 203 further enables user configuration of manner of storage of capillary vessel phase image storage, a user is able to select storage of a first capillary frame, frame containing maximum capillary blush 250, evenly spaced frames during capillary phase (fixed time interval 253, fixed frame spacing 256, fixed number of frames 259) and storage of all capillary phase frames 260 and a last capillary frame. Display image 203 also enables user configuration of manner of storage of venous vessel phase image storage, a user is able to select storage of a first venous frame, evenly spaced frames during venous phase (fixed time interval 273, fixed frame spacing 276, fixed number of frames 279) and storage of all venous phase frames 270 and a last venous frame 280.

User interface display image 203 enables user configuration of selection of image processing options to be applied to each image frame prior to storage. The image processing options enable a user to select use of automatic windowing (brightness/contrast or center/width) and automatic mask frame selection 292 comprising a frame immediately preceding the contrast injection (for subtracted images) or a frame immediately following radiation dose regulation. The selection of the mask image from a DSA image sequence affects image quality of subtracted images. A user is able to select a first image acquired in the sequence following the completion of radiation dose regulation. Dose regulation is a process of adjusting the X-ray power settings to achieve a presentation state of the images (too high a radiation dose produces burn-out and too little radiation dose can hide desired detail). A user is able to configure selection of an image immediately preceding entrance of contrast agent into vasculature as a mask image to minimize movement between an image at the start of acquisition of an image sequence and is also able to configure selection of an image indicating entrance of contrast agent since contrast agent may induce a burning sensation in a patient and sometimes results in involuntary patient movement.

Display image 203 enables user configuration of a pixel shift including, automatic pixel shift at specified region of interest (ROI) 294, automated pixel shift comprising performing multiple iterations of automatic pixel shift with different ROIs for selection of the best result 296 and a flexible pixel shift 298. Patient movement between images in a sequence is common and is compensated for by application of image specific pixel shift. Pixel shift is a shifting of an image being processed by a number of pixels along each coordinate axis in relation to a mask image to reduce the effect of movement artifact introduced in a digitally subtracted angiography image. System 10 automatic pixel shift employs a region of interest (ROI) to identify a focal spot to be evaluated in computing an optimal set of horizontal and vertical pixel shift values. The automated pixel shift is performed by processor 36 iteratively for different predetermined (or interactively determined) ROI locations in an image and processor 36 selects pixel shift values for a ROI that provides the best overall movement compensation. The configurable flexible pixel shift is applied to an image being processed and warps the image to produce an optimized subtracted image relative to a mask image. The flexible pixel shift is a non-linear transformation accommodating rotation and non-uniform movements.

Image 203 further enables a user to select image edge enhancement 300 and application of image averaging of a mask image 303 and averaging fill image frames 306. The edge enhancement function highlights edges between structures in an image and a selected mask image is averaged with some number of preceding and/or following images to produce a more noise tolerant image to be used in DSA subtraction. In performing fill averaging, an image being processed is averaged with a number of preceding and/or following images to produce a more noise tolerant image to be used in DSA subtraction. In performing automatic window/level adjustment in response to configuration option 320 selection, an optimal pair of window/level or contrast/brightness settings are selected for viewing a particular image. System 10 generates images to be stored to a PACS in response to user selection of how image processing is applied (i.e. including directly modifying the image pixel data or storing attributes in DICOM to have the processing applied by a display device) using display image 203. There is usually a factor that goes along with the edge enhancement to tune the result.

Another embodiment comprises a semi-automated system in which a user is able to select an image series or other collection of images and initiate storage to a PACS enabling a user to select automated “storage” settings to be applied to the series. In response to the selection, the system automatically applies the settings, generates the images, and transfers them to the PACS. In other embodiments partial automation is performed in differing degrees to simplify workflow and expedite a storage procedure.

System 10 is usable with X-ray imaging systems for image acquisition and review involving capture of time varying images of anatomy in which a contrast agent is introduced into arteries that can be visualized in the acquired images. The system advantageously provides a comprehensive overall combined storage workflow, including selection of image frames based on the phases of blood flow in vessels. User interface display image 203 enables user configuration of automated documentation of procedures that may be tailored to requirements of a specific institution, interventional suite, intervention type, or physician. User interface display image 203 enables configuring automated documentation by enabling a user to determine how documented images are selected and to select the image processing to be automatically applied to each image as well as to select annotations to be included in the documented images and set transfer options for documented images to be conveyed to a destination.

A user interface display image provided on display 19 enables a user to configure different types of image acquisition to provide acquisition specific automated documentation. System 10 advantageously configures an automatic process for documented angiographic procedures by automating the selection of specific images to document. System 10 advantageously provides automated selective documenting (archiving) of specific images from selected angiography acquisition sequences acquired during an interventional procedure in response to configuration of: image selection criteria, desired image processing, selection of annotations to be included, and selection of times in a procedure at which to perform the documentation. In response to configuration of automated image documentation, system 10 performs automated documentation transparently in the background for each angiographic (high dose X-ray) image sequence that is acquired. The user interface display image 203 provided on display 19 enables a user to select application of different image processing operations employed by system 10 for processing images to be archived.

A user may desire to view underlying anatomy that has been subtracted out by a digital subtraction process involving subtraction of a mask image. System 10 enables a user to subtract a proportion of the mask image from an image frame or add back a percentage of a mask image to a DSA image. A user interface display image enables user configuration of anatomic background image data processing 371 in documented images if the processing has been previously applied to an image). User interface display image 203 also enables user configuration of application of a specific anatomic background setting 373 to an image comprising the percentage of a mask image to be subtracted or added back if a mask image is already subtracted.

The user interface display image 203 provided on display 19 enables a user to select invert Intensity 323. Normally highly dense objects are displayed dark and low density objects as light. The invert intensity processing function reverses this portrayal making highly dense objects light and low density objects dark. Selecting option 323 applies the invert intensity image processing function to selected images. Selection of the flip Horizontal/Vertical image processing options 326, 329 flips an acquired image for review or documentation purposes about the horizontal or vertical axis of the image, respectively. Selection of the enable Zoom/Pan image processing option 332 zooms and pans an image during review on display 19 to focus on specific content in an image, for example. The function is applied to select zoom and pan settings of acquired images during review. Selection of image processing options 335 enables a user to determine when documentation processing is applied to acquired images A user is able to select image processing during a medical procedure (after completion of image acquisition), at procedure close, or at a later time, for example. This option either prohibits or allows a user to alter presentation state of images (via processing applied during image review) before the images are documented. System 10 enables a user to configure communication of a notification indicating completion of processing of images for documentation and storage in a PACs, for example.

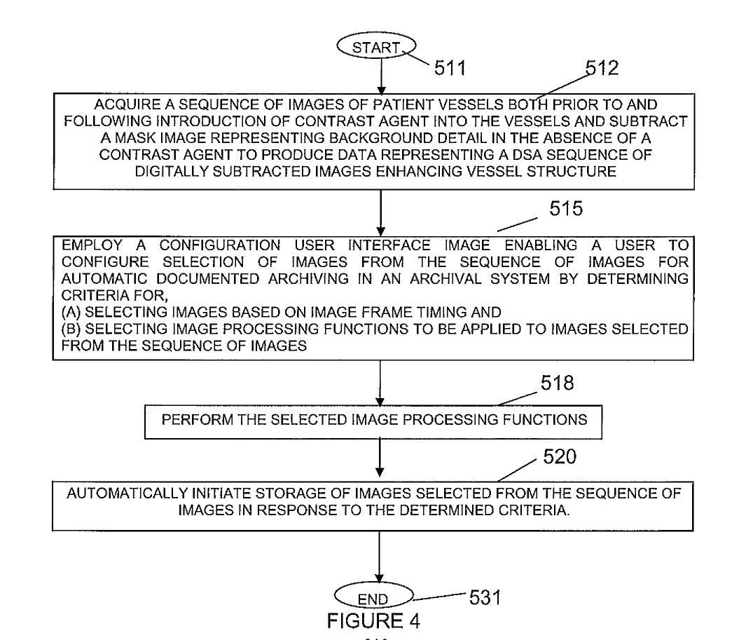

FIG. 4 shows a flowchart of a process used by automated medical image storage system 10. In step 512, following the start at step 511, interface 15 acquires a sequence of images of patient vessels both prior to and following introduction of contrast agent into the vessels and subtracts a mask image representing background detail in the absence of a contrast agent to produce data representing a DSA sequence of digitally subtracted images enhancing vessel structure. In step 515, configuration interface 31 enables a user to configure selection of images from the sequence of images for automatic documented archiving in an archival system by determining criteria to select images associated with one of arterial, venous, or capillary phases of blood flow. A user may also use interface 31 to configure selection of images from the sequence of images for automatic documented archiving by determining criteria for, (a) selecting images based on image frame timing, (b) selecting image processing functions to be applied to images selected from the sequence of images, (c) selecting images based on image frame time interval and (d) selecting annotations to be automatically added to selected images. The configuration interface enables a user to configure a time at which archival documentation processing is to occur. The time at which archival documentation processing is to occur is selected from at least two of, (a) during an imaging procedure, (b) at close of an imaging procedure and (c) at a specific time.

Configuration interface 31 enables a user to configure selection of images from the sequence of images by determining criteria to select images based on at least one of, a time interval between images, a fixed number of contiguous images and an image frame interval. The configurable image processing functions comprise at least one of, automatic fill averaging, automatic filtering, automatic background adjustment, automatic luminance intensity inversion, automatic flipping and enabling of zoom or pan, automatic mask frame selection, automatic pixel shift, automatic edge enhancement, automatic mask averaging and automatic window leveling adjustment. Further, the criteria for selecting images based on image frame timing determines at least one of, a time interval between images, a fixed number of contiguous images and an image frame interval. Image data processor 36 in step 518 performs the selected image processing functions to provide processed images. In step 520, output processor 29 automatically initiates storage of processed images corresponding to images selected from the sequence of images in response to the determined criteria. The process of FIG. 4 terminates at step 531.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-4 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system enables a user to configure processing functions to be applied to images as well as identification and selection of images associated with arterial, capillary, and venous phases of vascular blood flow and storage of the selected processed images. Further, the processes and applications may, in alternative embodiments, be located on one or more (e.g., distributed) processing devices on a network linking the units of FIG. 1. Any of the functions and steps provided in FIGS. 1-4 may be implemented in hardware, software or a combination of both.

What is claimed is:

1. An automated medical image storage system, comprising:
an interface for acquiring a sequence of images of patient vessels both prior to and following introduction of contrast agent into the vessels and subtracting a mask image representing background detail in the absence of a contrast agent to produce data representing a DSA sequence of digitally subtracted images enhancing vessel structure;
a configuration interface enabling a user to configure selection of images from said sequence of images for automatic documented archiving in an archival system by determining criteria to select images associated with one of arterial, venous, or capillary phases of blood flow; and
an output processor for automatically initiating storage of images selected from said sequence of images in response to the determined criteria.

2. A system according to claim 1, wherein
said configuration interface enables a user to configure selection of images from said sequence of images by determining criteria to select images based on at least one of, (a) a time interval between images, (b) a fixed number of contiguous images and (c) an image frame interval.

3. A system according to claim 2, wherein
said configuration interface enables a user to configure selection of annotations to be added to images selected from said sequence of images.

4. A system according to claim 3, wherein
said configuration interface enables a user to configure selection of image processing functions to be applied to images selected from said sequence of images.

5. A system according to claim 4, including
an image data processor for performing said image processing functions comprising at least one of (a) automatic mask frame selection, (b) automatic pixel shift, (c) automatic edge enhancement, (d) automatic mask averaging and (e) automatic window leveling adjustment.

6. A system according to claim 4, wherein
said image processing functions comprise at least one of, (a) automatic fill averaging, (b) automatic filtering, (c) automatic background adjustment, (d) automatic luminance intensity inversion, (e) automatic flipping and (f) enabling of zoom or pan.

7. A system according to claim 3, wherein
said configuration interface enables a user to configure a time at which archival documentation processing is to occur.

8. A system according to claim 7, wherein
said time at which archival documentation processing is to occur is selected from at least two of, (a) during an imaging procedure, (b) at close of an imaging procedure and (c) at a specific time.

9. An automated medical image storage system, comprising:
an interface for acquiring a sequence of images of patient vessels both prior to and following introduction of contrast agent into the vessels and subtracting a mask image representing background detail in the absence of a contrast agent to produce data representing a DSA sequence of digitally subtracted images enhancing vessel structure;
a configuration interface enabling a user to configure selection of images from said sequence of images for automatic documented archiving in an archival system by determining criteria for,
(a) selecting images based on image frame timing and
(b) selecting annotations to be automatically added to selected images; and
an output processor for automatically initiating storage of images selected from said sequence of images in response to the determined criteria.

10. A system according to claim 9, wherein
said criteria selects images associated with one of arterial, venous, or capillary phases of blood flow.

11. A system according to claim 9, wherein
said criteria for selecting images based on image frame timing determines at least one of, (a) a time interval between images, (b) a fixed number of contiguous images and (c) an image frame interval.

12. A system according to claim 9, wherein
said configuration interface enables a user to determine said criteria for selection of image processing functions to be applied to images selected from said sequence of images.

13. A system according to claim 12, wherein
said image processing functions comprise at least one of (a) automatic mask frame selection, (b) automatic pixel shift, (c) automatic edge enhancement, (d) automatic mask averaging and (e) automatic window leveling adjustment.

14. A system according to claim 12, wherein
said image processing functions comprise at least one of, (a) automatic fill averaging, (b) automatic filtering, (c) automatic background adjustment, (d) automatic luminance intensity inversion, (e) automatic flipping and (f) enabling of zoom or pan.

15. A system according to claim 9, wherein
said configuration interface enables a user to configure a time at which archival documentation processing is to occur.

16. A system according to claim 15, wherein
said time at which archival documentation processing is to occur is selected from at least two of, (a) during an imaging procedure, (b) at close of an imaging procedure and (c) at a specific time.

17. An automated medical image storage system, comprising:
an interface for acquiring a sequence of images of patient vessels both prior to and following introduction of contrast agent into the vessels and subtracting a mask image representing background detail in the absence of a contrast agent to produce data representing a DSA sequence of digitally subtracted images enhancing vessel structure;
a configuration interface enabling a user to configure selection of images from said sequence of images for automatic documented archiving in an archival system by determining criteria for,
(a) selecting images based on image frame timing and
(b) selecting image processing functions to be applied to images selected from said sequence of images;
an image data processor for performing the selected image processing functions to provide processed images; and
an output processor for automatically initiating storage of processed images corresponding to images selected from said sequence of images in response to the determined criteria.

18. A system according to claim 17, wherein
said criteria selects images associated with one of arterial, venous, or capillary phases of blood flow.

19. A system according to claim 17, wherein
said criteria for selecting images based on image frame timing determines at least one of, (a) a time interval between images, (b) a fixed number of contiguous images and (c) an image frame interval.

20. A system according to claim 17, wherein
said image processing functions comprise at least one of, (a) automatic mask frame selection, (b) automatic pixel shift, (c) automatic edge enhancement, (d) automatic mask averaging and (e) automatic window leveling adjustment.

21. A system according to claim 17, wherein
said image processing functions comprise at least one of, (a) automatic fill averaging, (b) automatic filtering, (c) automatic background adjustment, (d) automatic luminance intensity inversion, (e) automatic flipping and (f) enabling of zoom or pan.

22. A system according to claim 17, wherein
said configuration interface enables a user to select annotations to be automatically added to selected images.

23. A system according to claim 17, wherein
said configuration interface enables a user to configure a time at which archival documentation processing is to occur.

24. A system according to claim 17, wherein
said time at which archival documentation processing is to occur is selected from at least two of, (a) during an imaging procedure, (b) at close of an imaging procedure and (c) at a specific time.
